(19) United States
(12) Patent Application Publication
(10) Pub. No.: US 2005/0251211 A1
(43) Pub. Date: Nov. 10, 2005

(54) Multiple nipple pacifier

(76) Inventor: Carey Knifong, Milton-Freewater, OR (US)

Correspondence Address: LITMAN LAW OFFICES, LTD, PO BOX 15035, CRYSTAL CITY STATION, ARLINGTON, VA, 22215, US

(21) Appl. No.: 11/002,303

(22) Filed: Dec. 3, 2004

Related U.S. Application Data
(60) Provisional application No. 60/568,736, filed on May 7, 2004.

(51) Int. Cl. A61J 17/00

(52) U.S. Cl. 606/234

(57) ABSTRACT

The multiple nipple pacifier has a soft center support having a plurality of nipples projecting from the center support. The center support of the pacifier is preferably a geometric solid, such as a cube. Each face of the center support is concave to fit the contour of a child's mouth. One nipple extends from the middle of each concave face and each nipple comprises a stalk having a bulb-like end. The stalk of the nipple is preferably textured with a design that provides stimulation to the gums. The center support of the pacifier may enclose a housing that contains a vibrating mechanism to gently vibrate the pacifier and serve as an oral stimulator and/or a lighting mechanism to illuminate each face of the pacifier and therefore serve as a visual stimulator.

### CROSS-REFERENCE TO RELATED APPLICATION

This application claims the benefit of U.S. Provisional Patent Application Ser. No. 60/568,736, filed May 7, 2004.

### BACKGROUND OF THE INVENTION

1. Field of the Invention

The present invention relates to pacifiers, more particularly to a pacifier having multiple textured nipples that houses a vibrating mechanism and a light indicator mechanism.

2. Description of the Related Art

Pacifiers serve to soothe crying babies by allowing them to suck on the nipple of the pacifier. Oftentimes, babies mistakenly displace the nipple out of the mouth. Due to a lack of manual dexterity, developing children find it difficult to replace a displaced pacifier nipple within the mouth. This problem is compounded by the fact that traditional pacifiers have only one nipple disposed on a shield or a support. To overcome this problem, pacifiers having multiple nipples have been developed to make it easier for the child to find and place a nipple in the mouth. Pacifiers not only serve to soothe the child by allowing the child to suck on the nipple, but it also serves to orally stimulate the gum and mouth. However, a pacifier is needed that serves as a soothing device as well as a sensory device used to stimulate the child's oral senses and visual senses.

U.S. Pat. No. 1,268,470, issued to Johnson on Jun. 4, 1918, describes a rubber teething device for infants. The device shows six smooth, cylindrical shaped projections radiating from a central point. U.S. Des. Pat. No. 279,218, issued to Carpel on Jun. 11, 1985, illustrates a multiple nipple pacifier having ten projections of varying lengths and widths. U.S. Pat. No. 5,843,128 issued on Dec. 1, 1998, U.S. Des. Pat. No. 408,921 issued on Apr. 27, 1999, and U.S. Des. Pat. No. 410,747 issued on Jun. 8, 1999, all to Wexler, show pacifiers made of a pliable molded polymer having multiple nipples located at right angles around a ball-shaped center. U.S. Des. Pat. No. 200,618, issued to Proctor on Mar. 16, 1965, shows a pacifier having a ball-like center support and six smooth, tapered, cylindrical projections extending from the center support. Also, a teething ball shown on a web page published at www.greatbabyproducts.com/teethermunchkins.htm as of Apr. 30, 2004, shows a twistable ball having ten teething projections.

Dual nipple pacifiers are disclosed in U.S. Design Pat. No. 430,300, issued to-Anthony, Jr. on Aug. 29, 2000 (each nipple is attached to and extends from a rounded base) U.S. Pat. No. 3,601,129, issued to Seidl on Aug. 24, 1971; U.S. Pat. No. 6,436,125, issued to Rhoads on Aug. 20, 2002; and U.S. Pat. No. 5,211,656, issued to Maddocks et al. on May 18, 1993.

U.S. Design Pat. No. 219,631, issued to Bartels on Dec. 29, 1970, shows a pacifier having a relatively flattened and textured end. U.S. Design Pat. No. 336,520, issued to McDaniel on Jun. 15, 1993, shows a teether having two textured nipples disposed opposite each other. U.S. Pat. No. 2,115,405, issued to Allen on Apr. 26, 1938, describes a teething device having three projections with ridges, corrugations or protuberances disposed on the projections to massage the gums.

Other pacifiers, sucking, or teething devices are disclosed in Japanese Patent Number 6-339,514, published on Dec. 13, 1994; International Patent Number 94/09689, published on May 11, 1994 (sucking and teething instruments are tethered to a pillow having a bell disposed within the pillow); German Patent Number 19,839,904 published on Mar. 9, 2000 (a cuddly toy with sucking attachments); and German Patent Number 19,961,023 published on May 7, 2001 (doll having a nipple)

None of the above inventions and patents, taken either singly or in combination, is seen to describe the instant invention as claimed. Thus, a multiple nipple pacifier solving the aforementioned problems is desired.

### SUMMARY OF THE INVENTION

The multiple nipple pacifier comprises a soft center support having a plurality of nipples projecting from the center support. The center support of the pacifier is a geometric shape, preferably a cube, with each face of the center support being concave to fit the contour of a user's mouth. One nipple extends from the middle of each concave face, each nipple being a stalk having a bulb-like end. The stalk of the nipple is preferably textured with some design to enhance oral stimulation while sucking. The textured design on the stalk may be dots, convex circles, straight lines, curved lines, zigzags, “X” marks, or any other texture that provides stimulation to the gums. The center support of the pacifier can enclose an electrical housing that contains a vibrating mechanism to impart a gentle vibration on sore gums, and/or a light indicator mechanism to visually stimulate and entertain the user. For safety reasons, each face of the center support may have air holes disposed around the nipples. All edges and corners of the center support may be rounded and a slit may be disposed on the pacifier for attaching a pacifier clip. Optionally, the center support may be removable so that the nipples may be replaced when worn.

The shape of the center support or the number of nipples may be varied according to the present invention. For instance, the shape of the center support may be a pyramid, a prism, a hexagon or another geometric solid. Instead of nipples, one or more faces of the center support may have a handle, a ring, or a teething chew. The least number of nipples a pacifier according to the present invention may have is three.

These and other features of the present invention will be apparent upon review of the following specification and drawings.

### BRIEF DESCRIPTION OF THE DRAWINGS

FIG. 1 is an environmental, perspective view of a multiple nipple pacifier according to the present invention.

FIG. 2 is a perspective view of a multiple nipple pacifier according to the present invention.

FIG. 3 is a block diagram of the electronic components that may be housed in the center support of a multiple nipple pacifier according to the present invention.

FIG. 4 is a perspective view of an alternative embodiment of a multiple nipple pacifier of the present invention having handles on some of the faces of the center support in lieu of nipples.

FIG. 5 is a perspective view of another alternative embodiment of a multiple nipple pacifier of the present invention having a non-cubical center support.

Similar reference characters denote corresponding features consistently throughout the attached drawings.

### DETAILED DESCRIPTION OF THE PREFERRED EMBODIMENTS

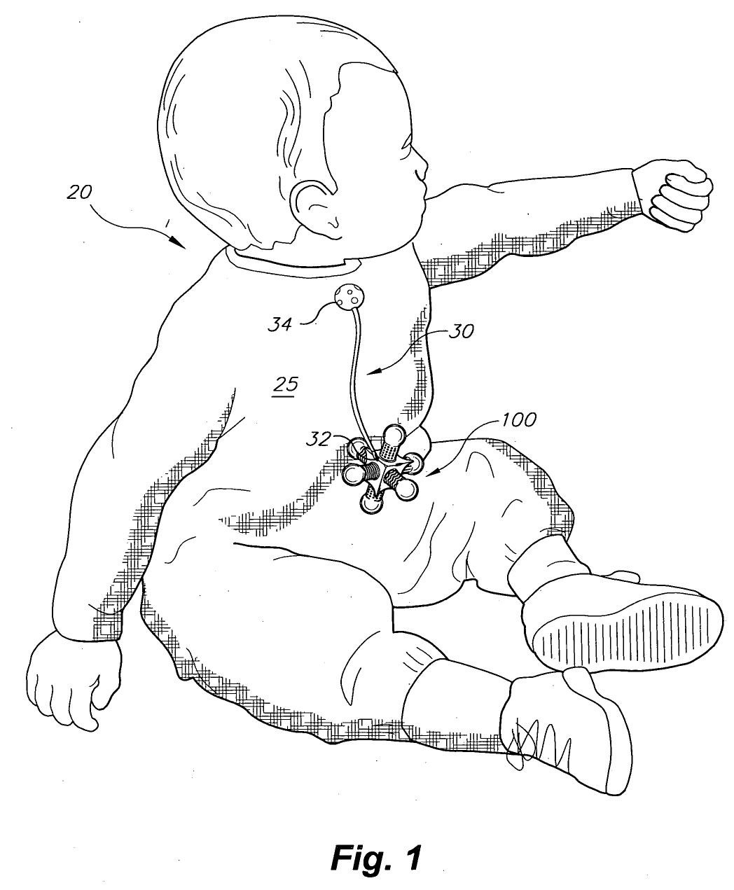

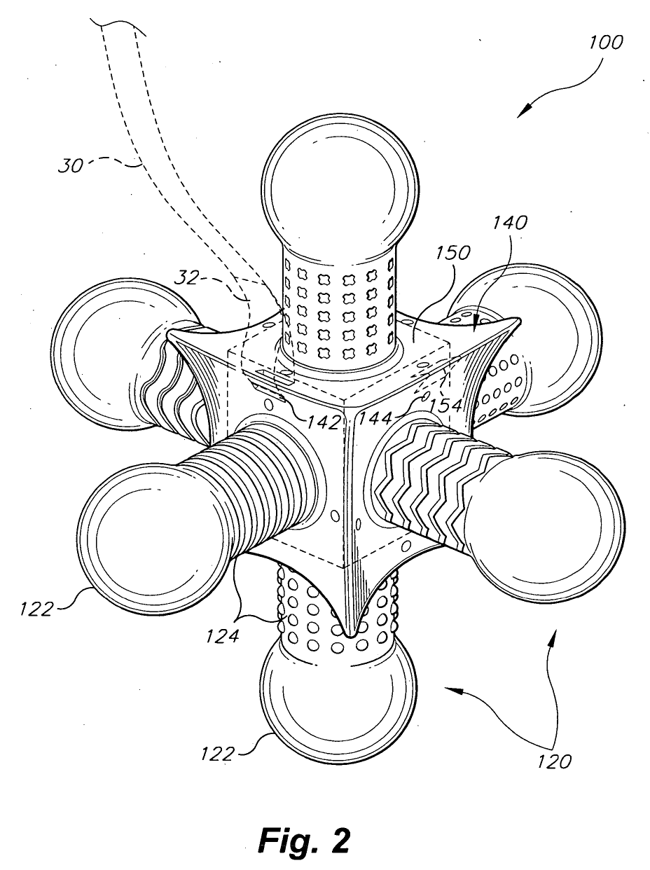

The present invention is a multiple nipple pacifier, designated as 100 in the figures. The pacifier 100 is shown in FIG. 1 suspended from a pacifier clip 30 worn by a child 20. A looped end 32 of the clip 30 is tied to the pacifier 100, specifically through a slit 142 (shown in FIG. 2) disposed on one edge of the pacifier 100, and a fastening end 34 of the clip 30 is attached to a garment 25 worn by the child 20.

Referring now to FIG. 2, the pacifier 100 comprises a center support 140 and a plurality of nipples 120 projecting from the center support 140. The center support 140 of the pacifier 100 is a geometric shape, preferably a cube. The six faces of the center support 140 are concave to fit the contour of the child's mouth. The concave shape of the face also aids in not leaving marks around the mouth when used as a pacifying device. For safety reasons, each face of the center support 140 preferably has a plurality of air holes 144 defined therein to allow air to pass through when sucking on the nipples 120. Also, the edges and corners of the center support 140 are rounded to prevent injury to the user.

The pacifier 100 is made from soft material. The center support 140 is preferably made from a soft, resilient plastic, such as synthetic rubber, or similar material. The material used to form the center support 140 ideally is transparent to permit light to pass through, with each face of the center support 140 being a different color. Alternatively, the center support 140 could be opaque with each face being the same color. The nipples 120 should be made out of latex, silicone, or similar material, as may be conventional in the art.

The nipples 120 project out from the center of each concave face of the center support 140. The nipple 120 comprises a stalk 124 and a rounded or a bulb-like end 122. The stalk 124 is ideally textured with a design 126, such as “X” marks, heart-shaped marks, diamond-shaped marks, concave dots, convex circles, zigzag lines, curved lines, straight lines, etc., that may stimulate the gums. Each nipple 120 is preferably textured with only one design 126; however, designs 126 on the stalk 124 of a single pacifier 100 may be mixed or the designs 126 may be repeated on two or more stalks 124 on one pacifier 100.

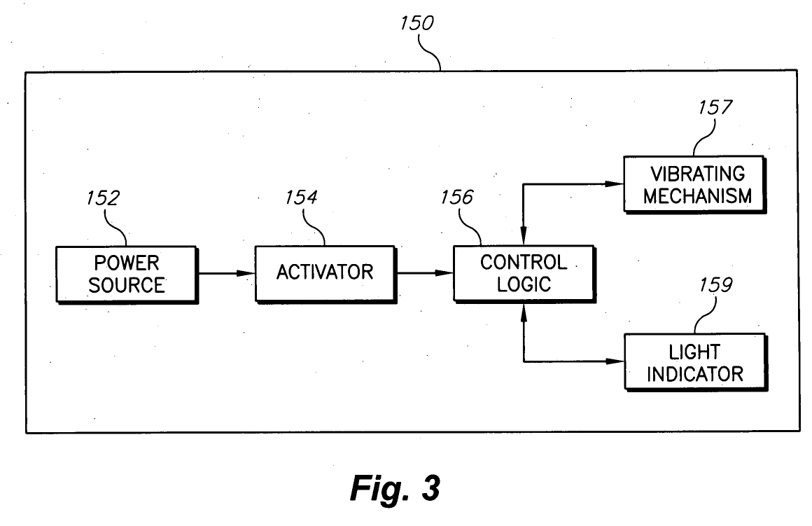

Referring now to FIG. 2 in conjunction with FIG. 3, an electrical housing 150 may optionally be disposed within the center support 140 of the pacifier 100. The housing 150 holds an electronic mechanism that would allow the pacifier 100 to vibrate, illuminate or both vibrate and illuminate. The electronic components may include a power source 152, an activator switch 154, a control logic 156, a vibrating mechanism 157 and/or a light indicator 159. The center support 140 may be a removable cover enclosing the electrical housing 150 so that the electrical housing 150 may be reused and placed in a new center support 140 when the nipples 120 are worn.

The power source 152 is preferably a small battery, such as the type used in watches or calculators. The power source 152 provides electrical power for the vibrating mechanism 157 and/or the light source. One or more activator switches 154 control the application of power to the vibratory mechanism 157 and/or the light source 159. The activator switch 154 is pressure operated, so that the electronic device is turned on by squeezing the center support 140. Alternatively, he activator 154 may be a push button switch disposed on an edge of the center support 140 that is easily depressed by either a parent or a child. The vibratory mechanism 157 may be a piezoelectric device or a vibratory motor. The light source 159 may be one or more light emitting diodes (LEDs), or a small incandescent bulb. The housing 150 is preferably waterproof to prevent the electronic components from being subject to moisture from humidity or saliva. The control logic 156 may include a timer to shut off the vibratory mechanism 157 or light source 159 after a preset period of time. The vibration mode may have one vibrating speed and intensity or different speeds and intensities depending upon the number of times the activator switch 154 is depressed, as determined by the control logic 156.

When the pacifier 100 includes the light source, the center support 140 is preferably made of a transparent plastic with each face being a different color. When the actuator switch 154 is depressed individual lights disposed behind each face of the center support 140 will illuminate each face alternatively. It is possible, however, that pacifier 100 could have one light disposed in the center support 140 which would illuminate the entire center support 140 either continuously or in a blinking or flashing manner. Here, as with the vibrating mechanism 157, the control logic 156 may include a timer that would automatically shut off the light(s) after a predetermined time.

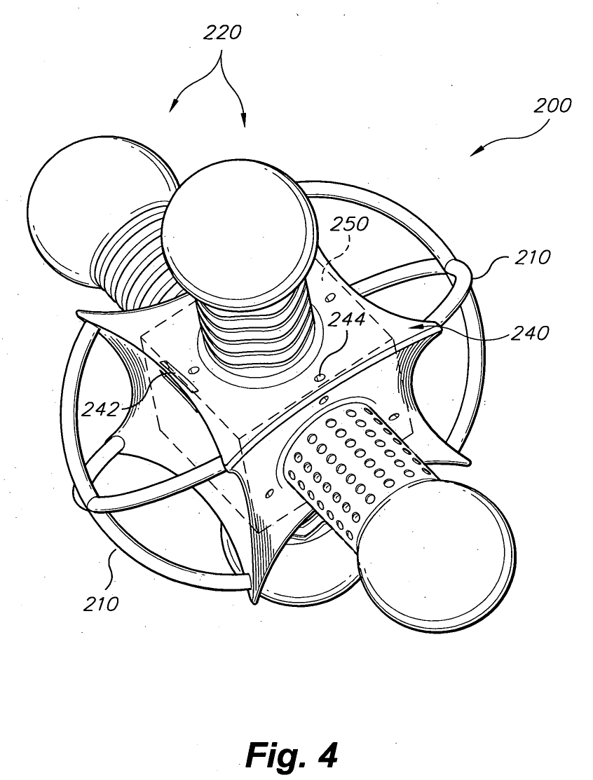

Pacifier 100 can be made in several different configurations, yet still posses the same basic features of the pacifier shown in FIGS. 2 and 3. For example, FIG. 4 shows pacifier 200, having a cubical center support 240, a housing 250, four nipples 220 and two handles 210. The handles 210 occupy faces on the center support 140 that lack nipples 220. Here, the two handles 210 are disposed on opposite faces so that the user may grasp the handles 210 when sucking on any of the four nipples 220. The pacifier 200 could have equally been made with one handle 210 and five nipples 220. Pacifier 200 varies from pacifier 100 based on the number of nipples 220. Instead of having handles 210 replace the faces lacking nipples 220, a teething chew or a ring may be provided.

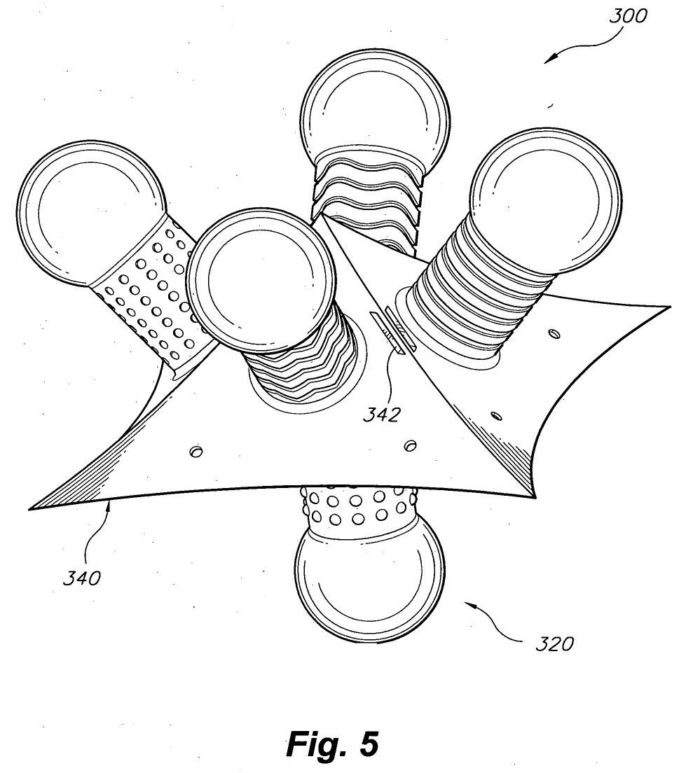

Other variations on pacifier 100 can be based upon the shape of the center support 140 in addition to the number of nipples 120 disposed on the pacifier 100. For example, alternative pacifier configurations based upon the shape of the center support may take the form of a pyramid, a prism, a hexagon, or any other geometric shapes. FIG. 5 shows pacifier 300 having a pyramidal center support 340. The pacifier 300 is a pyramid with five faces, each having a nipple 320 disposed thereon. Instead of each face of pacifier 300 having nipples 320 one or more face may retain a handle, a ring or a teething chew.

The pacifier 100 and its alternative embodiments should be made from soft material suitable for children. The pacifier may be made in different sizes to suit children in different age ranges such as three to six months, six to twelve months and twelve months and over. As an added feature the center support may be textured to enhance the user's tactile senses.

The pacifier 100 and the alternative embodiments are mainly used as a sucking device. The pacifier permits the user, especially a developing or infant child to easily manipulate and place at least one of the plurality of nipples in the mouth. The pacifier possessing the vibrating mechanism 157 may serve as a gentle oral stimulator especially to soothe sore gums on teething children. Also, the illuminating pacifier may serve as a visual stimulator and a learning device. For example, a parent may ask the child 20 to identify a face on the pacifier based on the color displayed on the face or to identify a particular color based on which face is being illuminated by the light indicator 159.

In each embodiment, the nipples may be of different sizes and the stalks of different lengths to accommodate children of different ages.

It is to be understood that the present invention is not limited to the embodiments described above, but encompasses any and all embodiments within the scope of the following claims.

1. A multiple nipple pacifier, comprising:
a center support having a plurality of faces;
a plurality of nipples extending from the faces of the center support; and
an electrical housing disposed within the center support.

2. The multiple nipple pacifier according to claim 1, further comprising a vibratory mechanism disposed within said electrical housing.

3. The multiple nipple pacifier according to claim 2, further comprising a circuit having a timer and control logic electrically connected to the timer and to the vibratory mechanism, the circuit being disposed within the electrical housing.

4. The multiple nipple pacifier according to claim 2, wherein the vibratory mechanism is a vibratory motor.

5. The multiple nipple pacifier according to claim 2, wherein the vibratory mechanism is a piezoelectric device.

6. The multiple nipple pacifier according to claim 2, wherein the vibrating mechanism has variable speed intensity.

7. The multiple nipple pacifier according to claim 1, further comprising a light source disposed within said electrical housing.

8. The multiple nipple pacifier according to claim 7, wherein the light source is a continuous light.

9. The multiple nipple pacifier according to claim 7, wherein the light source is a flashing light.

10. The multiple nipple pacifier according to claim 1, wherein the center-support has at least five-faces.

11. The multiple nipple pacifier according to claim 1, wherein the center support has at least four faces.

12. The multiple nipple pacifier according to claim 1, wherein the electrical housing is removable from the center support.

13. The multiple nipple pacifier according to claim 1, further comprising at least one handle extending from the a face of the center support.

14. The multiple nipple pacifier according to claim 1, wherein the faces of the center-support are concave.

15. The multiple nipple pacifier according to claim 1, wherein the center-support is made from a soft plastic.

16. The multiple nipple pacifier according to claim 16, wherein the plastic is resilient.

17. The multiple nipple pacifier according to claim 1, wherein the center support is transparent.

18. The multiple nipple pacifier according to claim 1, wherein the nipples are textured.

19. The multiple nipple pacifier according to claim 1, wherein the center-support has air holes disposed around each nipple.
